(19) United States
(12) Patent Application Publication
(10) Pub. No.: US 2007/0142143 A1
(43) Pub. Date: Jun. 21, 2007

(54) Twin caterpillar drive assembly

(76) Inventors: B. Stephan Speckhart, Short Hills, NJ (US); Alexander Flisfeder, Wayne, NJ (US); E. Robert Davis, Howell, NJ (US); D. Levi Hann, Andover, NJ (US)

Correspondence Address: KENYON & KENYON LLP, ONE BROADWAY, NEW YORK, NY, 10004, US

(21) Appl. No.: 11/286,207

(22) Filed: Nov. 23, 2005

(51) Int. Cl. F16H 7/08; F16H 61/00

(52) U.S. Cl. 474/101; 474/70

(57) ABSTRACT

A drive assembly for a mechanized clothes transfer mechanism, comprising a motor, a lead pulley, the motor connected to the lead pulley, a follower pulley, the follower pulley connected to the lead pulley through a timing chain, a timing chain tensioning arrangement configured to tension the timing chain between the lead pulley and the follower pulley, a first idler end pulley and a second idler end pulley, the first idler end pulley connected to the lead pulley through a first drive chain, the second idler end pulley connected to the follower pulley through a second drive chain, a drive chain tensioner configured to tension the first drive chain and the second drive chain, a structural support arrangement configured to support the lead pulley, the follower pulley, the first idler end pulley and the second idler end pulley in a coplanar orientation; and shear connectors connected to the first drive chain and the second drive chain, the shear connectors configured to interface with a conveyor chain of the mechanized clothes transfer mechanism.

### FIELD OF THE INVENTION

The present invention relates to a drive assembly for a mechanized clothes transfer mechanism. More particularly, the present invention provides a drive mechanism which allows for the capability to operate multiple conveyors or multiple areas of the same conveyor.

### BACKGROUND INFORMATION

Drive units for mechanized clothes transfer systems have several drawbacks which hamper use during daily operations. Drive units for mechanized clothes transfer systems must be controlled such that starting and stopping operations do not dislodge clothes placed upon the conveyor. Additionally, the starting and the stopping of the conveyor system must be accomplished in a controlled manner such that impulse forces are not transmitted throughout the system to the extent that structural damage occurs to the track and/or drive unit. Such controlled stops and starts of the system, however, are not easily performed. As clothes are placed upon and taken off of the clothes transfer mechanism, weight is shifted to and from different locations along the conveyor, placing localized stress upon the system. Stopping and starting the clothes conveying transfer system can be adversely affected by the shifting weight as the drive mechanism tries to cope with the shifted weight.

Designers of the mechanized clothes transfer systems, therefore, place a single extra-heavy duty drive unit to compensate for a maximum hypothetical weight to be placed upon the system. Additional factors of safety are used in the design of the drive unit to prevent the drive unit from premature failure. Such heavy duty drive units are expensive and not adaptable to system changes, such as when additional conveyor track is installed. Such track additions require removal of the heavy duty drive unit and replacement with an even larger drive unit. This results in economic inefficiency for the owner of the mechanized clothes transfer mechanism as the drive units must be removed and replaced during track additions or changes.

Operating safety is another component which is paramount in operation of mechanized clothes transfer systems. Sudden jerking of systems due to initiation of motion are to be avoided as these sudden movements can injure operators surprised by the sudden movements.

Efficient use of a drive system is also a problem with conventional mechanized clothes transfer devices. Conventional drive systems merely provide a single drive point for a clothes conveyor, therefore multiple drives are necessary to operate more than one clothes conveyor.

There is therefore a need to provide a drive system for a mechanized clothes transfer system which can provide needed mechanical actuation of the transfer system while providing economic benefit for the system owner.

There is an additional need to provide a mechanized clothes transfer mechanism which will be safe for operators by allowing graduated motion of the conveyor system during operation, allowing operators to perform required addition, withdrawal and maintenance operations.

There is a further need to provide a drive system for a mechanized clothes transfer system that allows for modification of the mechanized clothes transfer system as required by variations in business needs.

There is a further need to provide a drive system for a mechanized clothes transfer system such that multiple conveyors may be actuated by a single drive system.

### SUMMARY

It is therefore an objective of the present invention to provide a drive system for a mechanized clothes transfer system which can provide needed mechanical actuation of the transfer system, while providing economic benefit for the system owner.

It is also an objective of the present invention to provide a mechanized clothes transfer mechanism which will be safe for operators by allowing graduated motion of the conveyor system during operation, allowing operators to perform required addition and withdrawal operations as well as maintenance operations.

It is a further objective of the present invention to provide a drive system for a mechanized clothes transfer system that allows for modification of the mechanized clothes transfer system as required by variations in business needs.

It is also a further objective of the present invention to provide a drive system for a mechanized clothes transfer system such that multiple conveyors may be actuated by a single drive system.

The objectives of the present invention are achieved as illustrated and described. The present invention provides a drive assembly for a mechanized clothes transfer mechanism. The drive unit comprises a motor, a lead pulley, the motor connected to the lead pulley, a follower pulley, the follower pulley connected to the lead pulley through a timing chain. The present invention also provides a timing chain tensioning arrangement configured to tension the timing chain between the lead pulley and the follower pulley, a first idler end pulley and a second idler end pulley, the first idler end pulley connected to the lead pulley through a first drive chain, the second idler end pulley connected to the follower pulley through a second drive chain, a drive chain tensioner configured to tension the first drive chain and the second drive chain, a structural support arrangement configured to support the lead pulley, the follower pulley, the first idler end pulley and the second idler end pulley in a coplanar orientation, and shear connectors connected to the first drive chain and the second drive chain, the shear connectors configured to interface with a conveyor chain of the mechanized clothes transfer mechanism.

The shear connectors of the drive assembly for a mechanized clothes transfer mechanism may also be made of plastic. The motor may be connected to the lead pulley through gearing.

The drive assembly for a mechanized clothes transfer mechanism may also include conveyor drive chain guides connected to the structural support system configured to limit movement of the conveyor drive chains to a predefined limit.

The lead pulley and the follower pulley may be configured each with a first surface which interfaces with the timing chain. The lead pulley and the follower pulley are configured each with a second surface, the second surface of the lead pulley interfacing with the first drive chain to operate the first idler end pulley and the second surface of the follower pulley interfacing with the second drive chain to operate the second idler end pulley.

The drive assembly may also be configured such that the second surface of the lead pulley interfaces with the first drive chain through sprockets positioned on the exterior of the second surface. The timing chain tensioning arrangement is configured with a sprocket configured to interface with the timing chain.

The drive assembly for a mechanized clothes transfer mechanism may also include a control arrangement configured to interface with the motor wherein the control arrangement provides control commands to the motor. The control arrangement may be configured as one of a computer and a control board. The control arrangement may be further configured with an emergency deactivation device. The emergency deactivation device may be one of a motor brake and a power termination device.

For mounting the drive assembly of a mechanized clothes transfer mechanism, the structural support arrangement may be configured to be installed on a ceiling through anchor bolts.

The drive assembly may also be configured with a timing chain tensioning arrangement that is configured with a spring to provide tension to the timing chain.

The motor for the drive assembly may also be configured with a braking arrangement which may be a power cut-off switch. The braking arrangement may also include an alarm which may be a visual alarm or an audible alarm.

The drive assembly may also comprise a centrally mounted guide take-up assembly configured to limit drive chain lateral movement. Furthermore, the drive assembly may also have at least four pillow block bearings, each of the pillow block bearings supporting one of the lead pulley, the following pulley, the first idler pulley and the second idler pulley. The pillow block bearings may have an incorporated needle bearing or roller bearing.

### BRIEF DESCRIPTION OF THE DRAWINGS

FIG. 1 is a top view of a twin caterpillar drive assembly in conformance with the present invention.

FIG. 2 is a top view of the twin caterpillar drive assembly with items removed for clarity.

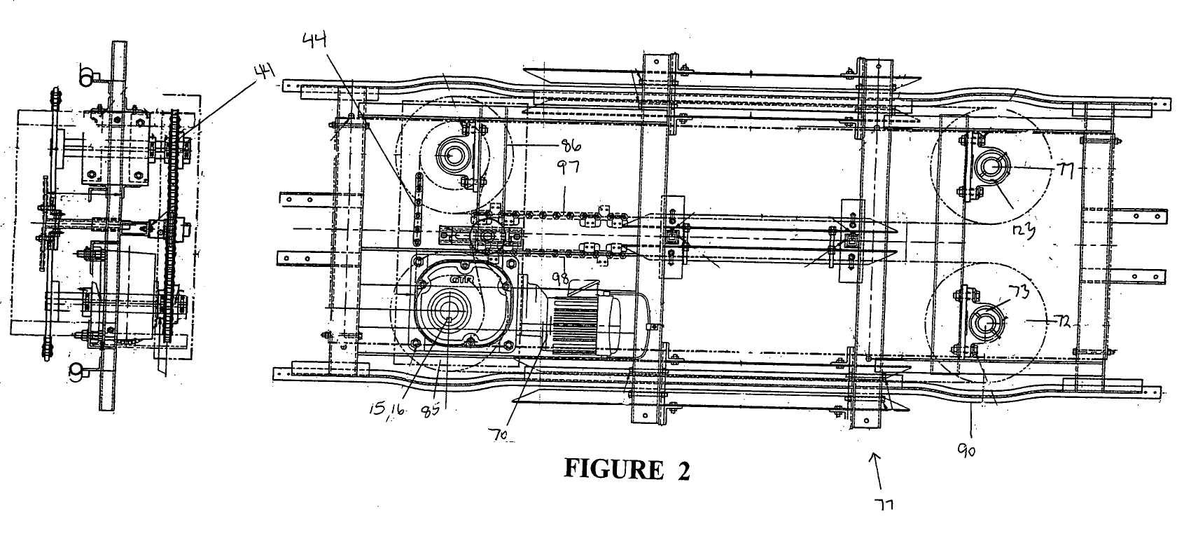

### DETAILED DESCRIPTION

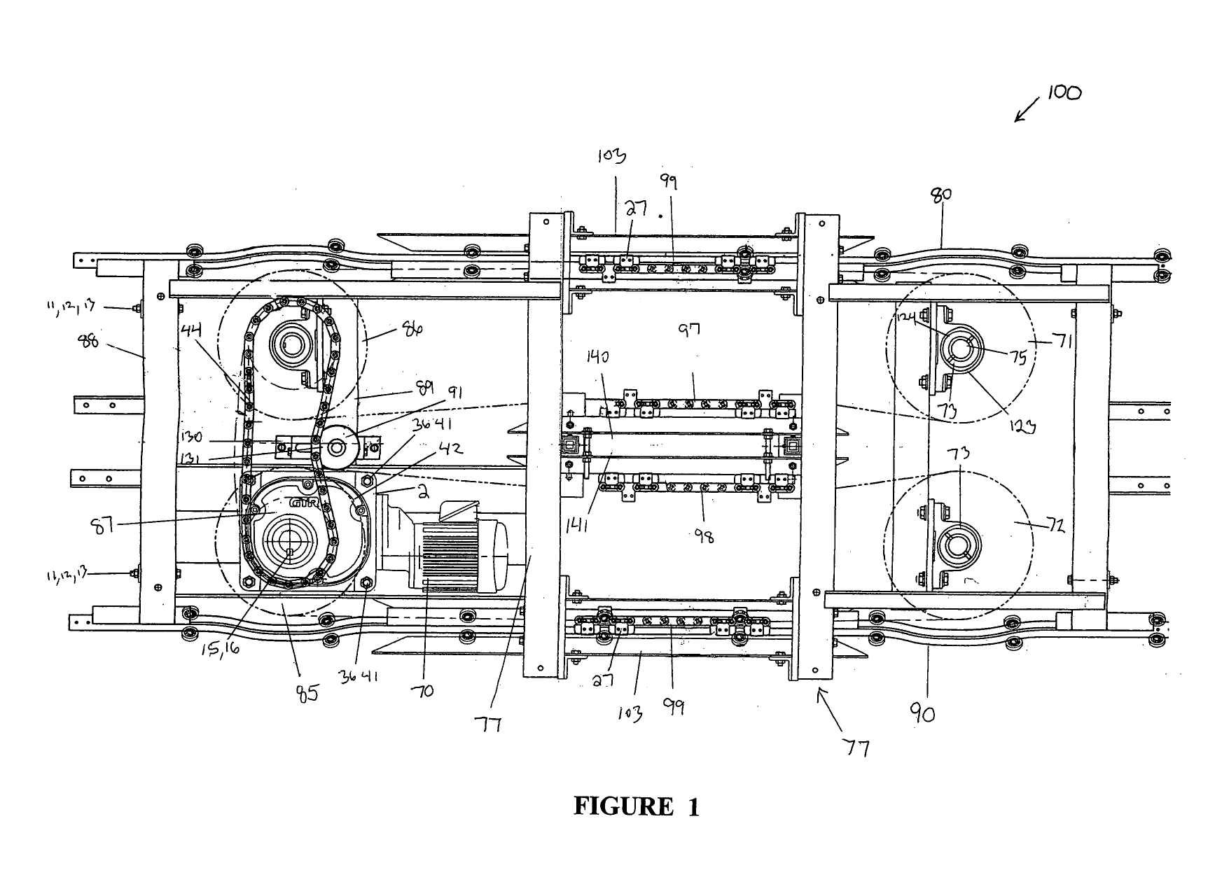

Referring to FIG. 1, a drive unit 100 for a mechanized clothes transfer device is illustrated. The drive unit 100 provides mechanical actuation of conveyors 80, 90 placed in juxtaposition to the unit 100. The conveyors 80, 90 may be individual units, or may be sections of the same conveyor. The drive unit 100 has a motor 70 which receives electrical input and, in the presently illustrated invention, through gearing, drives a lead pulley 85. The electrical input to the motor 70 may be secured by a conduit to the structural support arrangement 77 to prevent the electrical input lines from getting caught in/damaged by the timing chain 44, drive chains 98 or conveyor chains 99.

The motor 70 in the illustrated exemplary embodiment is a one horsepower motor with associated brake 42 operating at a three phase 230/460 volt input. The motor 70 is configured to be reversible, allowing the operator to operate the associated conveyors 80, 90 in a forward or backward motion. The brake 42 for the motor 70 may be an electromagnetic brake control device with thermal protection device with capability for instantaneous stops. The brake 42 may also be configured with an alarm, for example, an audible horn or a warning light to alert operators of brake 42 actuation. The motor 70 in the exemplary embodiment has a capability to be actuated through a number of speeds, thereby allowing the operator to choose the desired motive speed and force exerted on the conveyor. Motor controls, for example, can be through hand operated switches placed for convenience in an operator station. Additionally, the motor controls may be actuated through the use of a computer such that key entry data may allow for desired positioning of the conveyor(s) 80, 90 according to desired operator input commands. The motor 70, moreover, may also have an emergency stop feature and/or overload feature wherein binding of the conveyor(s) 80, 90 will allow quick disconnect of the motive force from the motor 70 to the conveyor. Alternatively, the motor 70 may be a two horsepower unit if greater motive force and/or speed is needed. In all motors to be used, an attached brake 42 may be provided such that sufficient braking force is created to reduce the speed of the motor 70. Other motor types and powers may be used as desired if greater or lesser motive force is required for the movement of the conveyor system.

The motor 70 is attached to the remainder of the drive unit 100 through bolts 36 and nuts 41 which penetrate a cross-member 2 that is part of the structural support arrangement 77. The cross-member 2 in the illustrated embodiment is a tubular steel member sized for impulse loads from activation and deactivation of the motor 70.

The lead pulley 85 is positioned on the remainder of the drive unit 100 through connection of a housing 87 to cross members 88, 89. The housing 87 is connected to the cross members 88, 89 by nut 13, bolt 12 and washer 11 assemblies located at four positions on the housing 87. A key 15 positioned in a keyway 16 allows the pulley 85 to be disengaged from the motor 70 in the case of excessive force preventing the pulleys from freely rotating. The key 15 is made of a specific material used to shear at a predetermined force level. The lead pulley 85 in the illustrated embodiment has an inner diameter surface and an outer diameter surface. The inner diameter surface is used to connect the lead pulley 85 to a following pulley 86 through a timing chain 44. The timing chain 44 extends between the lead pulley 85 and the following pulley 86 and is operated through sprockets positioned on both the lead pulley 85 and the following pulley 86. Although illustrated as using the inner diameter surface, other configurations can be used, and as such the illustrated embodiment is merely illustrative.

The structural support arrangement 77 allows the remainder for the components of the drive unit 100 to be supported. In the exemplary embodiment provided, the drive unit 100 is configured to be hung from a ceiling through the use of anchor bolts, such as Hilti Kwik Bolt II, in order to allow the components to be out of operators walking/working paths. The drive unit 100, however, is also configured to be placed on structural steel stands or it may be floor mounted if necessary. The structural support arrangement 77 is further configured to have individual housings placed around moving components therefore allowing the drive unit 100 to be self contained minimizing operator safety issues. The housings, moreover, may be provided with sound insulation material to ensure quiet operation. The structural support arrangement 77 is configured of non-corrosive material, such as stainless steel or aluminum for lightness of weight. The structural support may also be made of convention A36 carbon steel and coated for corrosion resistance.

In the illustrated present invention, the conveyor chain 99 is configured to drive carriers upon which clothes are placed. The conveyor chain 99 illustrated is a standardized configuration found on a conventional material clothes delivery system. A first 97 and a second drive chain 98 are positioned on the drive unit 100 to interface with the conveyor chains 99 to provide force to the conveyor 99 for movement. The force transfer between the conveyor chain 99 and the drive chains 97, 98 is achieved through sheer connectors 27 placed on the first and second drive chains 97, 98. The sheer connectors 27 placed on the first 97 and the second drive chains 98 are made of plastic so that excessive binding that occurs during a fault of the system will not result in breaking of components other than the sheer connectors. The sheer connectors 27 are configured to interface with differing types of chains to allow for movement of the drive chain 97, 98.

The present invention allows for the ability of multiple drive units to be placed on an existing conveyor system such that greater motive force can be retrofitted to systems in current operation. The addition of multiple drive units provides the heretofore unknown capability of series addition of motive force to conveyor systems. The multiple drive units may be controlled by a single computer system, for example, so that control of the drive unit 100 is maintained. Additionally, the creation of the series placement of the drive units allows the operator to accurately control the speed at which the conveyor operates. The conveyors may be operated at a very low speed to allow fine tuning adjustment of position per the needs of the operator.

The width of the overall drive unit 100 is also provided such that the unit may be installed in existing conveyor systems. As such, the spacing between the lead pulley 85, follower pulley 86 and first and second idler pulleys may be modified so that interface between the drive unit 100 and the existing conveyor system is smooth.

The conveyor drive chain 97, 98 is protected by guides 103 positioned along the sides of the drive unit 100. The guides provide for safety of operators from moving parts. Additionally, the guides 103 may be configured such that they are enclosed housings which provide for sound deadening capability. The guides 103 furthermore keep the conveyor drive chains 97, 98 in a predefined position, thereby preventing interaction between the drive chains and the conveyor chains 99. In the illustrated embodiment corresponding right hand guides and left hand guides are positioned along the drive unit 100 to protect operators during operation of the chain for an approximate length of 43.5 inches.

A drive chain adjustment screw 96 is provided in a centrally located position between the lead pulley 85/follower pulley and the idler pulleys 71, 72. The drive chain adjustment screw 96 allows the drive chains 97, 98 to be slackened or tightened to the required force. In the illustrated embodiment the chains 97, 98 should be tensioned between 15 and 20 pounds at the middle of the chain 97, 98 to provide a ⅛ inch to ⅜ inch overall chain deflection throughout the chain length from the lead/follower pulley and the respective idler pulley 71, 72.

The first idler pulley 71 and the second idler pulley 72 are positioned on the structural support arrangement 77 through the use of match drilled 3/16 inch holes which accommodate a bolt, washer and nut arrangement 120, 121, 122. The central section of the first idler pulley 71 and the second idler pulley 72 is a housing 123 which contains a split collar 124 with a 1⅝ inch bore. A pillow block 73 with a 1⅝ inch bore is placed within the housing. The pillow block 73 is used as a mounted bearing to provide load support for the rotating shaft axis of the associated pulley 71, 72. The pillow block bearing 73 is designed to support shaft protruding from the pulley in a parallel line with the axis of the shaft. In the illustrated embodiment, the pillow block bearing 73 is an aluminum pillow block with a self-aligning needle roller 74 bearing placed inside the pillow block 77. Other types of bearings may be used within the pillow block 73, therefore the illustrated embodiment is merely exemplary of the alternatives available. The bearings used can be self-lubricating, thereby allowing a minimum of maintenance. The housing can be a sintered aluminum unit, thereby minimizing weight of the design as well as corrosion from occurring. An additional roll pin 75 may be furthermore placed within the housing, thereby allowing the first and second idler pulleys 71, 72 to rotate about a defined axis. The roll pin in the illustrated exemplary embodiment is a ¼ inch by 3 inch unit, thereby allowing motion of the associated idler pulley. The first idler pulley 71, the second idler pulley 72, the lead pulley 85 and the follower pulley 86 are each configured to channel the respective drive chains 97, 98 and tensioning chains 44 such that the chains do not loosen or become dislodged during operation.

The drive unit 100, through the addition of the follower pulley 86 configuration, allows the operation of multiple sections of a conveyor through one driving mechanism. This allows for a centralized drive arrangement, producing ease of maintenance and troubleshooting. The drive unit 100 is configured as a single unit, therefore the entire unit may be installed or removed at a single time. The drive unit 100, however, is also configured such that individual pieces are removable thereby allowing maintenance to be accomplished on individual parts of the system. An example of this is a premature motor 70 failure wherein the motor 70 may be individually replaced with a comparable unit or, in the case of a system alteration, may be replaced with a larger or smaller unit as desired.

Position encoders may be used in the drive unit 100 to identify specific lateral displacement of chains, both tensioning and drive, to allow for determination of position of articles, for example, along a desired path. Alternatively, position encoders may be used on the conveyor chain 99 to record position of garments placed upon the conveyor system. The use of the position encoders and the corresponding recording of position of the system can be used by a control system such that motor 70 operation is controlled through position of the conveyor. Position encoders may use specific sections of the conveyor chain 99 as a reference mark, through reflectors, bar codes or other configurations.

A timing chain tensioner 91 is provided to allow the drive chain 97, 98 to be properly positioned and tensioned during movement of the motor 70. The timing chain tensioner 91 in the illustrated embodiment is provided with a support base 130, and a contact pulley 131 for contact with the drive chain 97, 98. The contact pulley 131 is provided with either a direct acting spring which keeps the pulley 131 and associated tensioner 91 in position relative to the position of the drive chain 97, 98. The timing chain tensioner 91 in the illustrated embodiment is a 15 tooth 7/8” shaft with associated pulley.

The drive chain 97, 98 and tensioning chain 44 in the illustrated embodiment of the present invention are conventional units with master links positioned on each of the individual chains to aid in removal for maintenance purposed. The chains 97, 98 may be made of stainless steel to limit degradation during operation and prevent corrosion from occurring. In the illustrated embodiment according to the present invention the drive chain 97, 98 is a roller chain 6ORC 56.25 inches in length with 75 individual sectional lengths.

The individual sections of the structural support arrangement 77 are configured to be assembled at a conveyor site, therefore each of the structural members is provided with attachment points which allow for connection to other structural members through the use of bolts and nuts. The structural members are configured with slotted holes to allow the structural members to adjusted to the needs of the individual facility.

The center support 140 for the drive assembly is also configured with a guide-take-up assembly 141. The guide take-up assembly 141 allows for channeling of the drive chain 97, 98 along the center of the drive assembly to prevent unintended horizontal motion of the drive chain 97, 98. The guide-take-up assembly 141 is configured such that both sheer connectors and chain link members are protected during rotary motion of the pulleys.

The sprocket of each pulley may be made of any material, such that the associated chain which comes in contact with the sprocket does not degrade. Appropriate materials may include, for example, stainless steel, carbon steel or other similar material.

The invention according to the present invention has several advantages compared to conventional drive units for mechanized clothes transfer apparatus. The drive unit 100 of the present invention allows for installation of more than one motor 70 thereby allowing operators to add additional motor capacity to move conveyor systems as required. Changes to existing conveyor systems may therefore be accomplished in an economical manner.

The present invention also allows the operation of either a single conveyor or can operate multiple conveyors from a single location. As the present invention allows for movement of multiple conveyors from a single drive point, the present invention allows for both ease of maintenance and a low number of moving parts as compared to complete drive systems. The present invention also allows for quick assembly, thereby minimizing downtime losses from inoperative equipment. Lastly, the present invention incorporates a safety features for protecting worker safety and allowing manipulation of controls for the drive unit 100.

In the foregoing specification, the invention has been described with reference to specific exemplary embodiments thereof. It will, however, be evident that various modifications and changes may be made thereunto without departing from the broader spirit and scope of the invention as set forth in the appended claims. The specification and drawings are accordingly to be regarded in an illustrative rather than in a restrictive sense.

1. A drive assembly for a mechanized clothes transfer mechanism, comprising:
a motor;
a lead pulley, the motor connected to the lead pulley;
a follower pulley; the follower pulley connected to the lead pulley through a timing chain;
a timing chain tensioning arrangement configured to tension the timing chain between the lead pulley and the follower pulley;
a first idler end pulley and a second idler end pulley, the first idler end pulley connected to the lead pulley through a first drive chain, the second idler end pulley connected to the follower pulley through a second drive chain;
a drive chain tensioner configured to tension the first drive chain and the second drive chain;
a structural support arrangement configured to support the lead pulley, the follower pulley, the first idler end pulley and the second idler end pulley in a coplanar orientation; and
shear connectors connected to the first drive chain and the second drive chain, the shear connectors configured to interface with a conveyor chain of the mechanized clothes transfer mechanism.

2. The drive assembly for a mechanized clothes transfer mechanism according to claim 1, wherein the shear connectors are made of plastic.

3. The drive assembly for a mechanized clothes transfer mechanism according to claim 1, wherein the motor is connected to the lead pulley through gearing.

4. The drive assembly for a mechanized clothes transfer mechanism according to claim 1, further comprising:
two conveyor drive chain guides connected to the structural support system configured to limit movement of the conveyor drive chains to a predefined limit.

5. The drive assembly for a mechanized clothes transfer mechanism according to claim 1, wherein the lead pulley and the follower pulley are configured each with a first surface which interfaces with the timing chain and the lead pulley and the follower pulley are configured each with a second surface, the second surface of the lead pulley interfacing with the first drive chain to operate the first idler end pulley and the second surface of the follower pulley interfacing with the second drive chain to operate the second idler end pulley.

6. The drive assembly for a mechanized clothes transfer mechanism according to claim 1, wherein the second surface of the lead pulley interfaces with the first drive chain through sprockets positioned on the exterior of the second surface.

7. The drive assembly for a mechanized clothes transfer mechanism according to claim 1, wherein the timing chain tensioning arrangement is configured with a sprocket configured to interface with the timing chain.

8. The drive assembly for a mechanized clothes transfer mechanism according to claim 1, further comprising:
a control arrangement configured to interface with the motor, wherein the control arrangement provides control commands to the motor.

9. The drive assembly of a mechanized clothes transfer mechanism according to claim 8, wherein the control arrangement is configured as one of a computer and a control board.

10. The drive assembly of a mechanized clothes transfer mechanism according to claim 9, wherein the control arrangement is further configured with an emergency deactivation device.

11. The drive assembly of a mechanized clothes transfer mechanism according to claim 10, wherein the emergency deactivation device is one of a motor brake and a power termination device.

12. The drive assembly of a mechanized clothes transfer mechanism according to claim 1, wherein the structural support arrangement is configured to be installed on a ceiling through anchor bolts.

13. The drive assembly of a mechanized clothes transfer mechanism according to claim 1, wherein the timing chain tensioning arrangement is configured with a spring to provide tension to the timing chain.

14. The drive assembly of a mechanized clothes transfer mechanism according to claim 1, wherein the motor has a braking arrangement.

15. The drive assembly of a mechanized clothes transfer mechanism according to claim 14, wherein the braking arrangement is a power cut off switch.

16. The drive assembly of a mechanized clothes transfer mechanism according to claim 14, wherein the braking arrangement includes an alarm.

17. The drive assembly of a mechanized clothes transfer mechanism according to claim 16, wherein the alarm is one of a visual alarm and an audible alarm.

18. The drive assembly of a mechanized clothes transfer mechanism according to claim 1, further comprising:
a centrally mounted guide take-up assembly configured to limit drive chain lateral movement.

19. The drive assembly of a mechanized clothes transfer mechanism according to claim 1, further comprising:
at least four pillow block bearings, each of the pillow block bearings supporting one of the lead pulley, the following pulley, the first idler pulley and the second idler pulley.

20. The drive assembly of a mechanized clothes transfer mechanism according to claim 19, wherein the pillow block bearing has an incorporated needle block bearing.

21. The drive assembly of a mechanized clothes transfer mechanism according to claim 19, wherein the pillow block bearing has an incorporated roller bearing.

22. The drive assembly of a mechanized clothes transfer mechanism according to claim 1, wherein the structural support arrangement is made of one of stainless steel, aluminum and carbon steel.
